(19) United States
(12) Patent Application Publication
(10) Pub. No.: US 2026/0103085 A1
(43) Pub. Date: Apr. 16, 2026

(54) ELECTRIFIED VEHICLE

(71) Applicants: HYUNDAI MOTOR COMPANY, Seoul (KR); KIA CORPORATION, Seoul (KR)

(72) Inventors: Joon Ha Hwang, Hwaseong-si (KR); Hee Won An, Hwaseong-si (KR); Seong Min Kim, Hwaseong-si (KR); Ho Sun Jang, Hwaseong-si (KR)

(73) Assignees: HYUNDAI MOTOR COMPANY, Seoul (KR); KIA CORPORATION, Seoul (KR)

(21) Appl. No.: 19/228,388

(22) Filed: Jun. 4, 2025

(30) Foreign Application Priority Data
Oct. 11, 2024 (KR) 10-2024-0138831

(51) Int. Cl. B60L 15/08; B60L 50/51; H02P 21/14; H02P 27/08

(52) U.S. Cl. CPC B60L 15/08; B60L 50/51; H02P 21/141; H02P 27/085; B60L 2210/42

(57) ABSTRACT

An electrified vehicle is provided. The electrified vehicle includes a controller configured to perform controlling of pulse width modulation for a first inverter through at least one of a first pulse width modulation method and a second pulse width modulation method according to a rotation speed of a motor when the motor is driven in a state in which an auxiliary battery is electrically connected to the motor through a node where each second end of a plurality of windings are interconnected.

### CROSS-REFERENCE TO RELATED APPLICATION(S)

The present application claims priority to Korean Patent Application No. 10-2024-0138831, filed Oct. 11, 2024, the entire contents of which are incorporated herein for all purposes by this reference.

### TECHNICAL FIELD

The present disclosure relates to an electrified vehicle and a control method of the electrified vehicle in which a main battery and/or an auxiliary battery is capable of being mounted therein.

### BACKGROUND

Recently, according to the global trend of carbon dioxide reduction in emissions, demand for electrified vehicles, which generate driving power by driving a motor with electrical energy stored in a battery, is increasing to replace conventional internal combustion engine vehicles that generate driving power through the combustion of fossil fuel.

A battery charging time of an electrified vehicle may be longer than a refueling time of an internal combustion engine vehicle, and thus the maximum driving distance of the electrified vehicle which may be driven with one full charge of a battery may be considered (e.g., important).

The maximum driving distance of the electrified vehicle may vary according to a voltage and a capacity of the battery. Even if batteries have the same capacity, a voltage and a charge amount thereof may be different according to a combination of series/parallel connection between modules or cells. For example, the voltage of the battery may correspond to a value obtained by multiplying the voltage of battery cells by the number of the cells connected in series, and the charge amount of the battery may correspond to a value obtained by multiplying the charge amount of battery cells by the number of cells connected in parallel.

Accordingly, a method of increasing the voltage of the battery may be considered for increasing the driving distance. However, when the voltage of the battery increases, the withstand voltage design of a motor system may be strengthened, so that a method capable of increasing the driving distance without increasing the voltage of the battery may be useful (e.g., desired).

The foregoing is intended to aid in the understanding of the background of the present disclosure.

### SUMMARY

Accordingly, the present disclosure is to provide an electrified vehicle capable of performing controlling of pulse width modulation so that a harmonic effect may be reduced when a motor is driven in a state in which an auxiliary battery and the motor are connected (e.g., to each other).

The present disclosure provides an electrified vehicle in which an auxiliary battery is capable of being mounted. The electrified vehicle includes a motor having a plurality of windings, a first inverter having a direct current link and having a plurality of legs connected to each first end of the plurality of windings, a main battery connected to the direct current link, and a controller configured to perform controlling of pulse width modulation for the first inverter through any one of a first pulse width modulation method and a second pulse width modulation method according to a rotation speed of the motor when the motor is driven in a state in which the auxiliary battery is mounted and the auxiliary battery is electrically connected to the motor through a node where each second end of the plurality of windings are interconnected (e.g., to each other).

According to the present disclosure, the auxiliary battery, along with the main battery, may be utilized for driving the motor, so that the driving distance of the electrified vehicle may be (e.g., efficiently) increased.

In addition, when the motor is driven in a state in which the auxiliary battery and the motor are electrically connected (e.g., to each other), the pulse width modulation method that is less affected by the harmonic effect is performed according to the rotation speed of the motor, so that the driving efficiency of the motor may be increased without adding a separate device.

The present disclosure is not limited to the above-mentioned effects, and other effects not mentioned herein may be provided from the description herein.

### BRIEF DESCRIPTION OF THE DRAWINGS

The above and other objectives and features of the present disclosure may be understood from the following detailed description when taken in conjunction with the accompanying drawings, in which:

FIG. 1 is a view of a configuration of an electrified vehicle according to an embodiment of the present disclosure;

FIG. 2 and FIG. 3 are views of examples of a motor system for use with embodiments of the present disclosure;

FIG. 4 is a graph of a first driving mode and a second driving mode according to an embodiment of the present disclosure;

FIG. 5 and FIG. 6 are views of a first pulse width modulation method according to an embodiment of the present disclosure;

FIG. 7 is a view of a second pulse width modulation method according to an embodiment of the present disclosure;

FIG. 8 and FIG. 9 are views of a determination reference of a pulse width modulation method according to an embodiment of the present disclosure; and

FIG. 10 is a flowchart showing a process of controlling pulse width modulation according to an embodiment of the present disclosure.

### DETAILED DESCRIPTION

The structural or functional description herein is intended to describe exemplary embodiments; however, the present disclosure may be variously embodied and may not be limited to the exemplary embodiments.

Embodiments described herein may be changed in ways and shapes, as embodiments are shown in the drawings and described in this specification are examples. Modifications, equivalents, and substitutions of the exemplary embodiments according to the present disclosure, with reference to the accompanying drawings, may be included in the present disclosure.

Hereinafter, exemplary embodiments disclosed herein will be described with reference to the accompanying drawings. In the present specification, the same or similar components will be denoted by the same or similar reference numerals, and a repeated description thereof may be omitted.

In the description of the embodiments herein, the term “preset” provides (e.g., means) that the numerical value of a parameter is determined in advance when the parameter is used in a process or algorithm. According to an example embodiment, the numerical value of a parameter may be set when a process or algorithm starts or may be set during a period in which the process or algorithm is executed.

In the description herein, the terms “module” and “part” contained in constituent elements may be selected or used together for convenience, and the expressions “module” and “part” may not have independent meanings or roles.

Some detailed descriptions may be omitted if the description obscures the embodiments of the present specification. In addition, the accompanying drawings are intended to describe the embodiments of the present specification, but the present specification is not limited to the embodiments in the accompanying drawings. The present specification may include modifications, equivalents, and substitutes included within the present disclosure.

Terms including ordinals such as “first” or “second” used herein may be used to describe various elements, but the elements may not be limited by the terms. The terms may be used to distinguish one constituent element from another constituent element.

When a component is described as “connected,” “coupled,” or “linked” to another component, that component may be (e.g., directly) connected, coupled, or linked to that other component. However, yet another component between each of the components may be present. In contrast, when a component is referred to as being “directly coupled” or “directly connected” to another component, there may be no intervening components present.

Singular expressions include plural expressions unless the context indicates otherwise.

Terms such as “including,” “having,” and the like are intended to indicate the features, numbers, steps, actions, elements, components, or combinations thereof disclosed in the specification, and are not intended to preclude one or more other features, numbers, steps, actions, elements, components, or combinations thereof may exist or may be added.

In addition, “unit” or “control unit” included in the names of the motor control unit (MCU) and the hybrid control unit (HCU) may (e.g., generally) refer to a controller that controls a (e.g., specific) function of the vehicle and may not provide (e.g., mean) a generic function unit.

In addition, a “controller” may include a communication device configured to communicate with another controller or a sensor in order to control a function assigned thereto, a memory configured to store an operating system, logic commands, and input and output information, and at least one processor configured to perform determination, calculation, and decision that may be used (e.g., necessary) to control the assigned function.

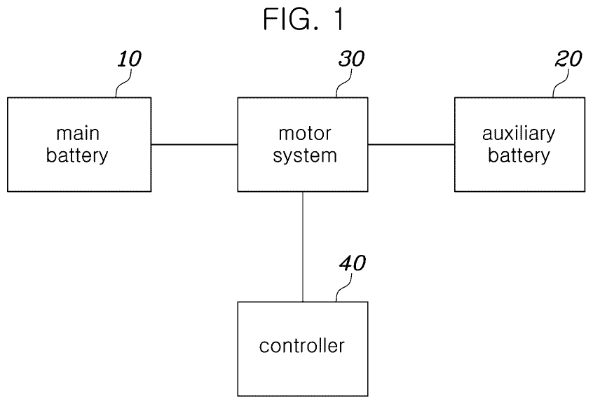

Before describing pulse width modulation, an electrified vehicle (e.g., applicable to embodiments of the present disclosure) will be described with reference to FIG. 1 to FIG. 3.

FIG. 1 is a view of a configuration of an electrified vehicle according to an embodiment of the present disclosure.

Referring to FIG. 1, an electrified vehicle according to an embodiment includes a main battery 10, a motor system 30, and a controller 40. An auxiliary battery 20 may be mounted in the electrified vehicle. Herein, the electrified vehicle according to an embodiment in a state in which the auxiliary battery 20 is mounted in the electrified vehicle will be described.

The motor system 30 may include a motor that is a power source of the electrified vehicle and may include at least one inverter that drives the motor, and the motor system 30 may be connected to the main battery 10 and the auxiliary battery 20 by being located therebetween.

In an example embodiment, the motor system 30 may drive the motor through an operation of the inverter based on a voltage of the main battery 10.

In addition, in the electrified vehicle according to an example embodiment, the auxiliary battery 20 may (e.g., optionally) be connected to the motor system 30. Furthermore, when the auxiliary battery 20 is connected to the motor system 30, the auxiliary battery 20 may supply power to the motor system 30. In example embodiments of the present disclosure, the auxiliary battery 20 is distinguished from the main battery 10. For example, a capacity or a voltage of the auxiliary battery 20 may have a value equal to or less than a capacity or a voltage of the main battery 10. In addition, since the auxiliary battery 20 is capable of being utilized for driving the motor 31, the auxiliary battery 20 is distinguished from a low voltage (for example, a 12V) battery for operating electrical components. Furthermore, the auxiliary battery 20 may have a larger capacity or a larger voltage than the low voltage battery for operating the electrical components.

In the example embodiment, the auxiliary battery 20 may be utilized as a power source for driving the motor, or may be utilized for charging the main battery 10 by supplying power to the main battery 10 through the motor system 30. In addition, the auxiliary battery 20 may be charged by receiving power from the main battery 10 through the motor system 30.

Meanwhile, the controller 40 may control a switching state (e.g., and the like) of the inverter included in the motor system 30. In addition, the controller 40 may control the motor system 30 according to a first driving mode in which the auxiliary battery 20 and the motor of the motor system 30 are (e.g., electrically) disconnected (e.g., from each other) or according to a second driving mode in which the auxiliary battery 20 and the motor of the motor system 30 are (e.g., electrically) connected (e.g., to each other). Thus, the controller 40 may generate a current command for the motor of the motor system 30 on the basis of a voltage modulation index.

In the example embodiments, the controller 40 may be implemented as a single controller, or may be implemented as a plurality of controllers having distributed functions. For example, the controller 40 may be implemented as a combination of a motor control unit (MCU) which is configured to control the motor of the motor system 30 and a control unit superior thereto (e.g., a hybrid control unit (HCU), a vehicle control unit (VCU), and a hydrogen fuel cell control unit (FCCU), and the like), but is not limited thereto. According to another example embodiment, the controller 40 may further include a charging controller.

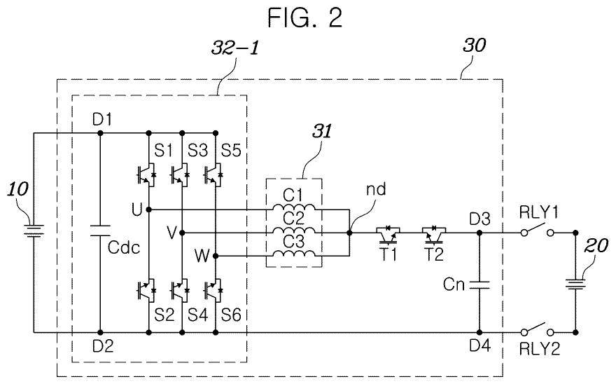

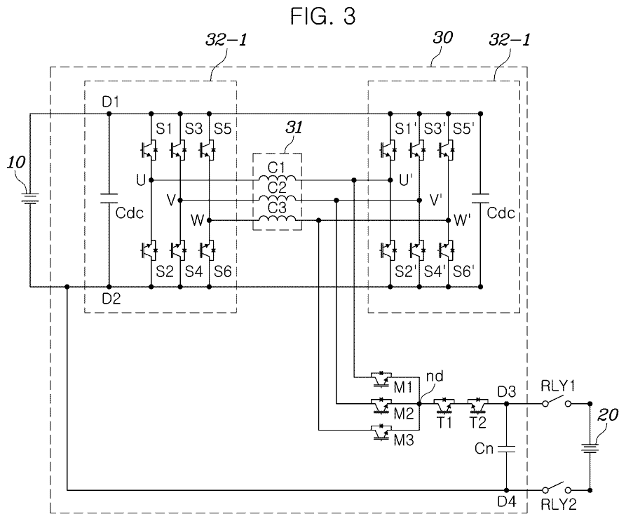

As described herein, the motor system 30 may be (e.g., electrically) connected to the main battery 10 and also to the auxiliary battery 20. Thus, a driving distance may be increased by driving the motor by utilizing the power of the auxiliary battery 20. A structure (e.g., for this purpose) is illustrated in FIG. 2 and FIG. 3.

FIG. 2 and FIG. 3 are views of examples of a motor system applicable to embodiments of the present disclosure.

FIG. 2 is a view of an example in which the motor system 30 is implemented as a single inverter 32-1 structure, and FIG. 3 is a view of an example in which the motor system 30 is implemented as a dual inverter 32-1 and 32-2 structure.

First, referring to FIG. 2, the motor system 30 according to an example embodiment may include a motor 31, a first inverter 32-1, charging switches T1 and T2, and direct current capacitors Cdc and Cn. In addition, the motor system 30 may have direct current links D1, D2, D3, and D4 that are connected to the main battery 10 and the auxiliary battery 20.

In an example embodiment, the motor 31 may include a plurality of windings L1, L2, and L3 corresponding to a plurality of phases U, V, and W, respectively. The first inverter 32-1 has the direct current links D1 and D2 connected to the main battery 10, and may include a plurality of legs S1-S2, S3-S4, and S5-S6 connected to each first end of the plurality of windings L1, L2, and L3 included in the motor 31.

The charging switches T1 and T2 may be connected to the auxiliary battery 20 and each second end of the plurality of windings L1, L2, and L3 included in the motor 31 by being located therebetween. In an example embodiment, the charging switches T1 and T2 may be connected to a node nd and a positive electrode of the auxiliary battery 20 by being located therebetween, and the node nd forms a neutral point of the motor 31 by the plurality of windings L1, L2, and L3 interconnected (e.g., to each other). In an example embodiment, the charging switches T1 and T2 may be implemented as an Insulated Gate Bipolar Transistor (IGBT), but may also be implemented as another element capable of performing a switching operation, such as a Metal Oxide Semiconductor Field Effect Transistor (MOSFET) and the like. Furthermore, although the charging switches T1 and T2 are connected in series in FIG. 2 and FIG. 3, a connection structure of the charging switches T1 and T2 is not limited thereto.

The first driving mode or the second driving mode described herein may be performed according to a turned-on/off state of the charging switches T1 and T2. In an example embodiment, in the first driving mode, the charging switches T1 and T2 are turned off. In this example embodiment, the node nd and the auxiliary battery 20 are (e.g., electrically) separated (e.g., from each other), and the auxiliary battery 20 is disconnected from the motor 31. In contrast, in the second driving mode, the charging switches T1 and T2 are turned on. In this example embodiment, the node nd and the auxiliary battery 20 are (e.g., electrically) connected (e.g., to each other), and the auxiliary battery 20 and the motor 31 are connected (e.g., to each other).

Meanwhile, the motor system 30 may be connected to the auxiliary battery 20 through relays RLY1 and RLY2. In this case, the relay RLY1 may be connected to the positive electrode of the auxiliary battery 20 and the direct current link D3 by being located therebetween, and the relay RLY2 may be connected to a negative electrode of the auxiliary battery 20 and the direct current link D4 by being located therebetween.

In example embodiments, the term “state in which the auxiliary battery 20 is mounted” may provide (e.g., mean) a state in which the auxiliary battery 20 is connected to the motor system 30 as the relays RLY1 and RLY2 are turned on. However, even when the relays RLY1 and RLY2 are turned on and the auxiliary battery 20 is mounted, the auxiliary battery 20 may be (e.g., electrically) connected to or disconnected from the motor 31 according to the turned-on/off state of the charging switches T1 and T2.

In an example embodiment, through the charging switches T1 and T2 and the relays RLY1 and RLY2, the positive electrode of the auxiliary battery 20 may be connected to the node nd formed at each second end of the plurality of windings L1, L2, and L3, and the negative electrode of the auxiliary battery 20 may (e.g., optionally) be connected to the direct current link D4.

Meanwhile, as illustrated in FIG. 1, a separate relay may not be provided between the main battery 10 and the motor system 30, but a relay may be provided between the main battery 10 and the motor system 30 according to an example embodiment.

The direct current capacitors Cdc and Cn may be provided to reduce current ripples. In an example embodiment, the direct current capacitor Cdc connected to the direct current link D1 and the direct current link D2 by being located therebetween may reduce ripples on the current of the main battery 10, and the direct current capacitor Cn connected to the direct current link D3 and the direct current link D4 by being located therebetween may reduce ripples on the current of the auxiliary battery 20.

Herein, the motor system 30 illustrated in FIG. 3 will be described with a focus on the differences from the motor system 30 illustrated in FIG. 2.

Referring to FIG. 3, in another example embodiment, the motor system 30 may further include a second inverter 32-2, and a plurality of changeover switches M1, M2, and M3 in comparison with the motor system 30 in FIG. 2.

The second inverter 32-2 may include a plurality of legs (S1′-S2′, S3′-S4′, and S5′-S6′ connected to each second end of the plurality of windings L1, L2, and L3.

The plurality of changeover switches M1, M2, and M3 may have each first end connected to each second send of the plurality of windings L1, L2, and L3, and may have each second end interconnected (e.g., to each other), thereby forming the node nd. The plurality of changeover switches M1, M2, and M3 may determine a detailed driving mode through the first inverter 32-1 and the second inverter 32-2 in the first driving mode.

In an example embodiment, the first driving mode may include a Closed End winding (CEW) mode and an Open End winding (OEW) mode. First, in the CEW mode, the plurality of changeover switches M1, M2, and M3 are turned on. In the example embodiment, the node nd is the neutral point of the motor 31, and the motor 31 is driven (e.g., only) by the first inverter 32-1. Such a CEW mode may be performed for (e.g., efficient) driving of the motor 31 in a low power section.

In comparison, in the OEW mode in the first driving modes, the plurality of changeover switches M1, M2, and M3 are turned off. In the example embodiment, the node nd does not become the neutral point of the motor 31, and the motor 31 may be driven by the second inverter 32-2 along with the first inverter 32-1. Such an OEW mode may be performed in order to increase a driving power of the motor 31 in a high power section.

Meanwhile, in the dual inverter 32-1 and 32-2 structure, the auxiliary battery 20 may be connected to the direct current link D5 and each second end of the plurality of windings L1, L2, and L3 by being located therebetween. In an example embodiment, through the charging switches T1 and T2 and the relays RLY1 and RLY2, the positive electrode of the auxiliary battery 20 may be connected to the node nd formed at each second end of the plurality of changeover switches M1, M2, and M3, and the negative electrode of the auxiliary battery 20 may be connected to the direct current link D5.

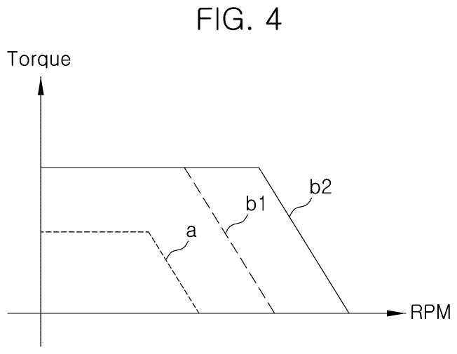

Herein, each operation region of the first driving mode and the second driving mode will be (e.g., briefly) described with reference to FIG. 4.

FIG. 4 is a graph of the first driving mode and the second driving mode according to an embodiment of the present disclosure.

Referring to FIG. 4, each operation region of the first driving mode and the second driving mode may be provided (e.g., expressed) as graphs of a rotation speed and a torque of the motor 31.

First, an OEW mode b1 may be performed in a low power section having a relatively low rotation speed and a relatively low torque compared to that of an OEW mode b2. Conversely, the OEW mode b2 may be performed in a high power section having a relatively high rotation speed and a relatively high torque compared to that of the CEW mode b1.

The second driving mode a may be performed within an operation section of the CEW mode b1, and may be performed at a lowest power section having a relatively low rotation speed and a relatively low torque. In the lowest power section, the auxiliary battery 20 along with the main battery 10 is utilized for driving the motor 31, so that the driving distance may be increased.

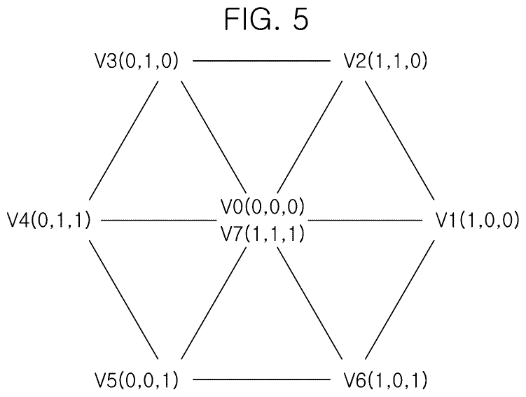

Meanwhile, in the electrified vehicle according to an example embodiment, when the auxiliary battery 20 is mounted and the motor 31 is driven in a state in which the auxiliary battery 20 is (e.g., electrically) connected to the motor 31 through the node nd where each second end of the plurality of windings is interconnected (e.g., to each other) (e.g., the second driving mode is operated), controlling of pulse width modulation for the first inverter 32-1 may be performed through (e.g., any) one of a first pulse width modulation method and a second pulse width modulation method according to a rotation speed of the motor 31. Herein, before describing a determination reference of the pulse width modulation method, each of the first pulse width modulation method and the second pulse width modulation method will be described with reference to FIGS. 5-7.

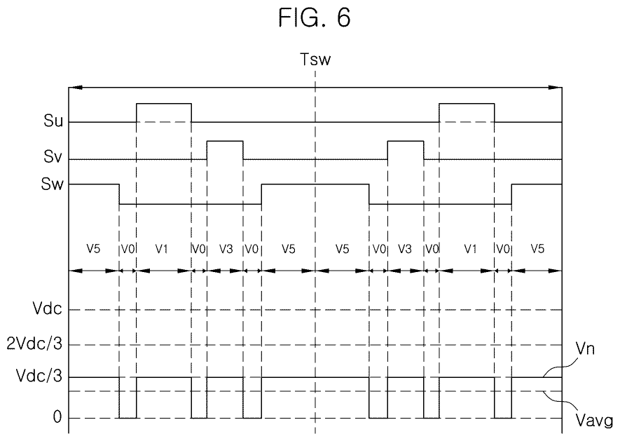

First, FIG. 5 and FIG. 6 are views of the first pulse width modulation method according to an embodiment of the present disclosure.

Referring to FIG. 5 and FIG. 6, the first pulse width modulation method according to an embodiment may be provided (e.g., defined) as a method of synthesizing three effective voltage vectors having a phase difference of 120 degrees (e.g., from each other) and a zero voltage vector in a complex space provided (e.g., expressed) in FIG. 5 and then determining a neutral point voltage Vn applied to the node nd of the motor 31.

In this example embodiment, the effective voltage vectors may be provided (e.g., expressed) as V1 (1, 0, 0), V2 (1, 1, 0), V3 (0, 1, 0), V4 (0, 1), V5 (0, 0, 1), V5 (0, 0, 1), V6 (1, 0, 1), and V7 (1, 1, 1) according to the switching state of each phase. Furthermore, according to synthesizing of such effective voltage vectors, the neutral point voltage Vn of the motor 31 may be determined to be any values of 0, Vdc/3, 2 Vdc/3, and Vdc. Here, 1 represents a state in which top switching elements S1, S3, and S5 of each phase are turned on, 0 represents a state in which bottom switching elements S2, S4, and S6 are turned on, and the Vdc corresponds to a voltage of the direct current links D1 and D2.

In an example embodiment, the first pulse width modulation method may be performed through voltage vectors V1, V3, V5, or V2, V4, and V5 that have a phase difference of 120 degrees (e.g., from each other) among the effective voltage vectors. In the example embodiment, the neutral point voltage Vn may be controlled by including a zero voltage vector V0 between each effective voltage vector.

For example, referring to FIG. 6, a process of pulse width modulation through the effective voltage vectors V1, V3, and V5 having a phase difference of 120 degrees (e.g., from each other) and the zero voltage vector V0 is illustrated. During an (e.g., entire) switching cycle Tsw, the legs S1-S2, S3-S4, and S5-S6 included in the first inverter 31-2 and corresponding to each phase may be switched according to a vector order such as V5-V0-V1-V0-V3-V0-V5-V5-V0-V3-V0-V1-V0-V5. Through this, the neutral point voltage Vn may be controlled to Vdc/3 or 0 during the (e.g., entire) switching cycle Tsw. In addition, the first pulse width modulation method may be performed by using the effective voltage vectors V2, V4, and V6 having the phase difference of 120 degrees (e.g., from each other) and the zero voltage vector V0. In this example embodiment, the neutral point voltage Vn may be determined to be 2 Vdc/3 or 0.

Such a first pulse width modulation method may be provided (e.g., expressed) as a Remote State PWM (RSPWM) in that the effective voltage vectors having the phase difference are used. However, in the first pulse width modulation method according to an example embodiment, the effective voltage vectors may have the phase difference (e.g., from each other) and also may have the zero voltage vector that may be used together.

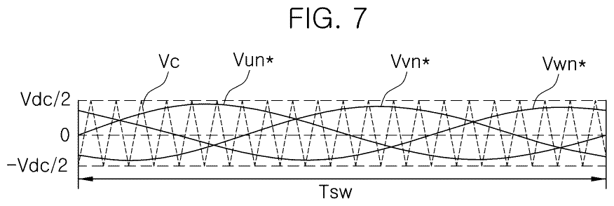

A second pulse width modulation method performed in a different manner will be described with reference to FIG. 7.

FIG. 7 is a view of the second pulse width modulation method according to an embodiment of the present disclosure.

Referring to FIG. 7, the second pulse width modulation method according to an embodiment may be provided (e.g., defined) as a method of determining the switching state of the plurality of legs S1-S2, S3-S4, and S5-S6 included in the first inverter 32-1 by comparing voltage commands Vun*, Vvn*, and Vwn* for the first inverter and a predetermined triangular carrier wave Vc during the switching cycle Tsw.

In this example embodiment, a peak-peak value of the triangular carrier wave Vc may be set to the voltage Vdc of the direct current links D1 and D2, and the switching state of the legs S1-S2, S3-S4, and S5-S6 corresponding to each phase may be determined according to a magnitude relationship between the triangular carrier wave Vc and the voltage commands Vun*, Vvn*, and Vwn*.

For example, when each value of the voltage commands Vun*, Vvn*, and Vwn* of each phase exceeds a value of the triangular carrier wave Vc, the top switching elements S1, S3, and S5 of each of the legs S1-S2, S3-S4, and S5-S6 may be turned on. Conversely, when each value of the voltage commands Vun*, Vvn*, and Vwn* of each phase exceeds the value of the triangular carrier wave Vc, the bottom switching elements S2, S4, and S6 of each of the legs S1-S2, S3-S4, and S5-S6 may be turned on.

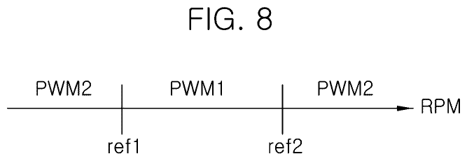

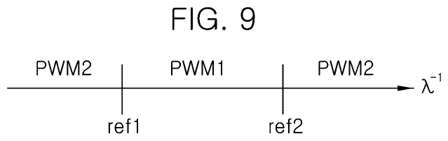

Meanwhile, the reference by which the controller 40 according to an embodiment determines whether to perform pulse width modulation using the first pulse modulation method or the second pulse modulation method will be described herein with reference to FIG. 8 and FIG. 9.

FIG. 8 and FIG. 9 are views of a determination reference of a pulse width modulation method according to an embodiment of the present disclosure.

First, referring to FIG. 8, the controller 40 may perform controlling of pulse width modulation for the first inverter 32-1 by using (e.g., any) one of the first pulse width modulation method PWM1 and the second pulse width modulation method PWM2 according to which section, of a plurality of rotation speed sections (e.g., divided by predetermined reference rotation speeds ref1 and ref2), the rotation speed of the motor 31 is included in.

In this example embodiment, the reference rotation speeds ref1 and ref2 may be set to a rotation speed value that allows a difference between a frequency of the neutral point current of the motor 31 according to the control of pulse width modulation through the first pulse width modulation method PWM1 and a frequency of the neutral point current of the motor 31 according to the control of pulse width modulation through the second pulse width modulation method PWM2 to be included within a predetermined error range.

In addition, the reference rotation speed may include a first reference rotation speed ref1 and a second reference rotation speed ref2 having a value equal to or more than that of the first reference rotation speed ref1, thereby dividing the rotation speed section into at least three rotation speed sections. For example, the first reference rotation speed ref1 may be a reference for dividing a section in a relatively low speed section such as 1 krpm to 5 krpm, and the second reference rotation speed ref2 may be a reference for dividing a section in a relatively high speed section exceeding 5 krpm.

This may be due to a harmonic effect when the first pulse width modulation method PWM1 and the second pulse width modulation method PWM2 are performed according to the rotation speed section of the motor 31, and perform controlling of pulse width modulation through a pulse width modulation method in which the harmonic effect is relatively low for each rotation speed section.

In an example embodiment, in the controller 40, the first pulse width modulation method PWM1 is more affected by the harmonic effect than the second pulse width modulation method PWM2 in the low and high speed regions, so that the pulse width modulation that is used (e.g., beneficial) for reducing the harmonic effect is performed for each rotation speed section.

For example, when the rotation speed of the motor 31 is included in a section between the first reference rotation speed ref1 and the second reference rotation speed ref2, the controller 40 may perform controlling of pulse width modulation through the first pulse width modulation method PWM1 that is used (e.g., beneficial) for reducing the harmonic effect in a medium speed region. In addition, when the rotation speed of the motor 31 is included in at least one of a section below the first reference rotation speed (that is, the low speed region) and a section exceeding the second reference rotation speed (that is, the high speed region), controlling of pulse width modulation through the second pulse width modulation method PWM2 that is used (e.g., beneficial) for reducing the harmonic effect in the low speed and high speed regions may be performed.

Meanwhile, the controller 40 may determine the method to be used for controlling pulse width modulation by further considering the voltage applied to the motor 31 through the first inverter 32-1. In an example embodiment, the controller 40 may determine a pulse width modulation method according to a reverse magnetic flux determined by a ratio of the rotation speed of the motor 31 to an input voltage (e.g., Vdc) of the first inverter 32-1. In this regard, herein, the description will be described with reference to FIG. 9.

Referring to FIG. 9, the controller 40 may perform controlling of pulse width modulation for the first inverter 32-1 by using any one of the first pulse width modulation method PWM1 and the second pulse width modulation method PWM2 according to which section, of a plurality of reverse magnetic flux sections (e.g., divided by predetermined reference reverse magnetic fluxes ref1′ and ref2′), the reverse magnetic flux (e.g., based on the ratio of the rotation speed to the voltage) is included in.

In this example embodiment, the reference reverse magnetic fluxes ref1′ and ref2′ may be set to a reverse magnetic flux value that allows a difference between a frequency of the neutral point current of the motor 31 according to the control of pulse width modulation through the first pulse width modulation method PWM1 and a frequency of the neutral point current of the motor 31 according to the control of pulse width modulation through the second pulse width modulation method PWM2 to be included within a predetermined error range.

In addition, the reference reverse magnetic flux may include a first reference reverse magnetic flux ref1′ and a second reference reverse magnetic flux ref2′ having a value equal to or more than that of the first reference reverse magnetic flux ref1′, thereby dividing the reverse magnetic flux section into at least three reverse magnetic flux sections. For example, the first reference reverse magnetic flux ref1′ may be a reference for dividing a section in a relatively low reverse magnetic flux section, and the second reference reverse magnetic flux ref2′ may be a reference for dividing a section in a relatively high reverse magnetic flux section.

This may be due to the harmonic effect when the first pulse width modulation method PWM1 and the second pulse width modulation method PWM2 are performed varying according to the reverse magnetic flux section, and is to perform controlling of pulse width modulation through a pulse width modulation method in which the harmonic effect is relatively low for each reverse magnetic flux section.

For example, when the reverse magnetic flux is included in a section between the first reference reverse magnetic flux ref1′ and the second reference reverse magnetic flux ref2′, the controller 40 may perform controlling of pulse width modulation through the first pulse width modulation method PWM1 that is used (e.g., beneficial) for reducing the harmonic effect in the corresponding region. For example, when the reverse magnetic flux is included in at least one of a section below the first reference reverse magnetic flux ref1′ and a section exceeding the second reference reverse magnetic flux ref2′, controlling of pulse width modulation through the second pulse width modulation method PWM2 that is used (e.g., beneficial) for reducing the harmonic effect in the corresponding regions may be performed.

Meanwhile, such a determination of the pulse width modulation method may be performed by referring to a predetermined table. For example, the controller 40 may perform controlling of pulse width modulation for the first inverter 32-1 on the basis of an output value of the predetermined table in which the rotation speed of the motor 31 and the voltage applied to the motor 31 are used as input values and at least one (e.g., any) of the first pulse width modulation method PWM1 and the second pulse width modulation method PWM2 is used as the output value.

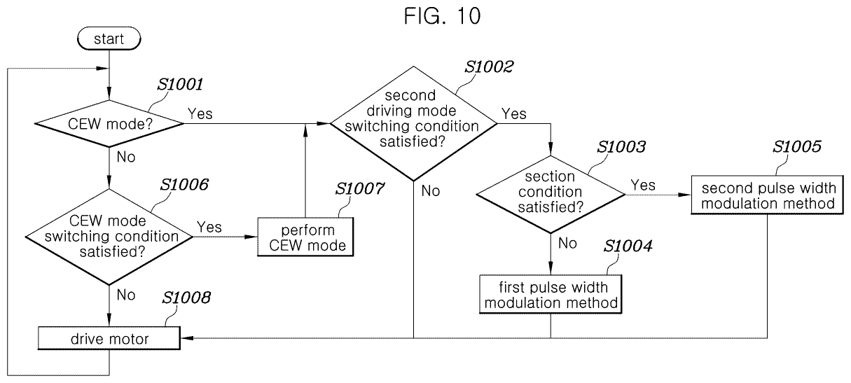

Herein, the process of controlling pulse width modulation described so far will be described with reference to FIG. 10.

FIG. 10 is a flowchart showing the process of controlling pulse width modulation according to an embodiment of the present disclosure.

Referring to FIG. 10, the controller 40 may determine the pulse width modulation method S1004 and S1005 by determining whether a preset section condition is satisfied (S1003) when a switching condition for the second driving mode is satisfied (Yes in S1002) during the execution of the CEW mode in the first driving mode (Yes in S1001).

In this case, the section condition may be determined on the basis of the rotation speed and the voltage of the motor 31 described herein. For example, the condition may be set to be satisfied when the rotation speed of the motor 31 is included in the section between the first reference rotation speed ref1 and the second reference rotation speed ref2 or when the reverse magnetic flux is included in the section between the first reference reverse magnetic flux ref1′ and the second reference reverse magnetic flux ref2′.

When the pulse width modulation method is determined through the process, the controller 40 performs the pulse width control through the determined method, and drives the motor 31 (S1008).

Meanwhile, even when the CEW mode in the first driving mode is not performed (No in S1001), the CEW mode may be performed (S1007) when the switching condition for the CEW mode is satisfied (Yes in S1006). In this example embodiment, when the switching condition for the second driving mode is satisfied (Yes in S1002), the process described above may be performed. However, when the switching condition for the second driving mode is not satisfied (No in S1002), the motor 31 is driven through the first driving mode S1008.

According to the example embodiments of the present disclosure as described herein, the auxiliary battery along with the main battery may be utilized for driving the motor, so that the driving distance of the electrified vehicle may be (e.g., efficiently) increased.

In addition, when the motor is driven in a state in which the auxiliary battery and the motor are (e.g., electrically) connected (e.g., to each other), the pulse width modulation method that is less affected by the harmonic effect is performed according to the rotation speed of the motor, so that the driving efficiency of the motor may be increased without adding a separate device.

Although exemplary embodiments of the present disclosure have been described herein, the present disclosure should not be limited to these exemplary embodiments and that changes and modifications can be made within the scope of the present disclosure.

What is claimed is:

1. An electrified vehicle in which an auxiliary battery is capable of being mounted, the electrified vehicle including:
a motor including a plurality of windings;
a first inverter including a direct current link and a plurality of legs connected to each first end of the plurality of windings;
a main battery connected to the direct current link; and
a controller configured to control pulse width modulation for the first inverter through at least one of a first pulse width modulation method and a second pulse width modulation method based on a rotation speed of the motor when the motor is driven in a state in which the auxiliary battery is mounted and the auxiliary battery is electrically connected to the motor through a node where each second end of the plurality of windings are interconnected.

2. The electrified vehicle of claim 1, wherein the controller is configured to control pulse width modulation for the first inverter through at least one of the first pulse width modulation method and the second pulse width modulation method based on whether the rotation speed of the motor is included in a section of a plurality of rotation speed sections, wherein the plurality of rotation speed sections are divided by a predetermined reference rotation speed.

3. The electrified vehicle of claim 2, wherein the reference rotation speed is a reference speed that provides a difference between a frequency of a neutral point current of the motor according to the control of pulse width modulation through the first pulse width modulation method and a frequency of a neutral point current of the motor according to the control of pulse width modulation through the second pulse width modulation method to be included in a predetermined error range.

4. The electrified vehicle of claim 2, wherein the reference rotation speed includes a first reference rotation speed and a second reference rotation speed that has a value equal to or more than that of the first reference rotation speed.

5. The electrified vehicle of claim 4, wherein, when the rotation speed of the motor is included in a section between the first reference rotation speed and the second reference rotation speed, the controller performs the control of pulse width modulation through the first pulse width modulation method.

6. The electrified vehicle of claim 5, wherein the first pulse width modulation method is a method of determining a neutral point voltage of the motor by synthesizing three effective voltage vectors and a zero voltage vector, the three effective voltage vectors having a phase difference of 120 degrees in a complex space.

7. The electrified vehicle of claim 4, wherein, when the rotation speed of the motor is included in at least one of a section below the first reference rotation speed and a section exceeding the second reference rotation speed, the controller performs the control of pulse width modulation through the second pulse width modulation method.

8. The electrified vehicle of claim 7, wherein the second pulse width modulation method is a method of determining a switching state of the plurality of legs by comparing a voltage command for the first inverter and a predetermined triangular carrier wave.

9. The electrified vehicle of claim 1, wherein the controller is configured to perform the controlling of pulse width modulation for the first inverter through at least one of the first pulse width modulation method and the second pulse width modulation method by further considering an input voltage of the first inverter.

10. The electrified vehicle of claim 9, wherein the controller is configured to perform the controlling of pulse width modulation for the first inverter through at least one of the first pulse width modulation method and the second pulse width modulation method according to a reverse magnetic flux by a ratio between the rotation speed of the motor and the input voltage of the first inverter.

11. The electrified vehicle of claim 10, wherein the controller is configured to perform the controlling of pulse width modulation for the first inverter through at least one of the first pulse width modulation method and the second pulse width modulation method according to whether the reverse magnetic flux is included in a section of a plurality of reverse magnetic flux sections, wherein the plurality of reverse magnetic flux sections are divided by a predetermined reference reverse magnetic flux.

12. The electrified vehicle of claim 11, wherein the reference reverse magnetic flux is a reverse magnetic flux that provides a difference between a frequency of a neutral point current of the motor according to the control of pulse width modulation through the first pulse width modulation method and a frequency of a neutral point current of the motor according to the control of pulse width modulation through the second pulse width modulation method to be included in a predetermined error range.

13. The electrified vehicle of claim 12, wherein the reference reverse magnetic flux includes a first reference reverse magnetic flux and a second reference reverse magnetic flux that has a value equal to or more than that of the first reference reverse magnetic flux.

14. The electrified vehicle of claim 13, wherein, when the reverse magnetic flux is included in a section between the first reference reverse magnetic flux and the second reference reverse magnetic flux, the controller performs the control of pulse width modulation through the first pulse width modulation method.

15. The electrified vehicle of claim 14, wherein the first pulse width modulation method is a method of determining a neutral point voltage of the motor by synthesizing three effective voltage vectors and a zero voltage vector, the three effective voltage vectors having a phase difference of 120 degrees in a complex space.

16. The electrified vehicle of claim 13, wherein, when the reverse magnetic flux is included in at least one of a section below the first reference reverse magnetic flux and a section exceeding the second reference reverse magnetic flux, the controller performs the control of pulse width modulation through the second pulse width modulation method.

17. The electrified vehicle of claim 16, wherein the second pulse width modulation method is a method of determining a switching state of the plurality of legs by comparing a voltage command for the first inverter and a predetermined triangular carrier wave.

18. The electrified vehicle of claim 9, wherein the controller is configured to control pulse width modulation for the first inverter based on an output value of a predetermined table in which the rotation speed of the motor and the input voltage of the first inverter are used as input values and at least one of the first pulse width modulation method and the second pulse width modulation method is used as the output value.

19. The electrified vehicle of claim 1, further including:
a second inverter including a plurality of legs connected to each second end of the plurality of windings,
wherein, when the auxiliary battery is mounted but the motor is driven in a state in which the auxiliary battery and the motor are electrically disconnected, the controller is configured to perform at least one of a Closed End Winding (CEW) mode in which the motor is driven through the first inverter and an Open End Winding (OEW) mode in which the motor is driven through the first inverter and the second inverter.

20. The electrified vehicle of claim 19, further including:
a plurality of changeover switches having each first end thereof connected to each second end of the plurality of windings, the plurality of changeover switches having each second end thereof interconnected forming a node,
wherein the controller is configured to control by the CEW mode or the OEW mode through turned-on/off states of the plurality of changeover switches.
